(19) United States
(12) Patent Application Publication
(10) Pub. No.: US 2026/0054416 A1
(43) Pub. Date: Feb. 26, 2026

(54) CEMENT DRY ADDITIVE SYSTEM

(71) Applicant: Schlumberger Technology Corporation, Sugar Land, TX (US)

(72) Inventors: Bartley Patton, Houston, TX (US); Victor F. Blanco, Houston, TX (US)

(21) Appl. No.: 18/792,890

(22) Filed: Aug. 23, 2024

(51) Int. Cl. B28C 7/04; B28C 7/00; B28C 7/10; B28C 7/12

(52) U.S. Cl. CPC B28C 7/049; B28C 7/0084; B28C 7/10; B28C 7/128

(57) ABSTRACT

A dry additive mixing system includes a dry additive dispenser, piping, a mix tank, and a controller. The dry additive dispenser includes a storage hopper, a weight batch hopper connected to the storage hopper, and a transfer auger configured to move dry additive from the storage hopper into the weight batch hopper. The piping is connected to the dry additive dispenser. The mix tank is connected to the piping. The controller is configured to control the transfer auger to move dry additive into the weight batch hopper until a target amount of dry additive in the weight batch hopper is reached, and selectively release the target amount of dry additive into the piping.

### CROSS-REFERENCE TO RELATED APPLICATIONS

Not applicable.

### BACKGROUND

### Field

The present disclosure relates to cement production. More particularly, the present disclosure relates to blending additives with water for use in cement operations.

### Description of the Related Art

Additives are often added into water used to hydrate dry cement to control a thickening time and/or viscosity of the cement. Dry additives blended with dry cement often separate while in storage. Additionally, liquid additives are often complex to transport and are negatively affected by cold weather.

### SUMMARY

In general, disclosed herein are methods, systems, and apparatuses for mixing dry additives into water for use in cementing operations.

Some embodiments, provide a dry additive mixing system including a dry additive dispenser, piping, a mix tank, and a controller. The dry additive dispenser includes a storage hopper, a weight batch hopper connected to the storage hopper, and a transfer auger configured to move dry additive from the storage hopper into the weight batch hopper. The piping is connected to the dry additive dispenser. The mix tank is connected to the piping. The controller is configured to control the transfer auger to move dry additive into the weight batch hopper until a target amount of dry additive in the weight batch hopper is reached, and selectively release the target amount of dry additive into the piping.

In some embodiments, the dry additive mixing system also a static mixer fluidly placed along the piping,

In some embodiments, the dry additive mixing system also includes a plurality of valves fluidly placed along the piping, wherein the controller is configured to control the plurality of valves to selectively fill the mix tank with fluid, selectively release admix water from the mix tank a selectively circulate fluid through the piping.

In some embodiments, the plurality of valves are electrically actuable.

In some embodiments, the dry additive mixing system also includes a plurality pumps fluidly placed along the piping, wherein the controller is configured to control the plurality of pumps to selectively fill the mix tank with fluid, selectively release admix water from the mix tank, and selectively circulate fluid through the piping.

In some embodiments, each of the plurality of pumps includes a rotation sensor.

In some embodiments, the controller monitors fluid flow rate in the piping and fluid volume in the mix tank via the rotation sensor.

In some embodiments, the controller is configured to control the transfer auger to measure out an initial amount of dry additive and a secondary amount of dry additive.

In some embodiments, the secondary amount of dry additive is less than the initial amount of dry additive.

In some embodiments, the target amount of dry additive is the sum of the initial amount of dry additive and the secondary amount of dry additive.

In some embodiments, a first auger screw of the transfer auger measures the initial amount of dry additive and a second auger screw of the transfer auger measures the secondary amount of dry additive.

In some embodiments, the second auger screw is smaller than the first auger screw.

In some embodiments, the transfer auger includes a rotation sensor.

In some embodiments, the controller monitors measurement of the initial amount of dry additive and measurement of the secondary amount of dry additive via the rotation sensor.

In some embodiments, the dry additive mixing system also includes an eductor connected to the weight batch hopper and the piping, wherein the controller is configured to control the eductor to selectively release the target amount of dry additive into the piping.

Some embodiments provide a dry additive mixing system including a mix tank, a dry additive dispenser, and a controller. The dry additive dispenser is connected to the mix tank via piping. The dry additive dispenser is configured to dispense a dry additive into the piping. The controller is in communication with the dry additive dispenser. The controller is programmable to control the dry additive dispenser according to an admix water production program via an interface, wherein a user enters desired dry additive concentration values for one or more stages via the interface.

In some embodiments, the interface is displayed via one or more of a display of the controller and a remote computing device in communication with the controller.

In some embodiments, the user may update the admix water production program via the interface dynamically while the admix water production program is running.

Some embodiments provide a method to produce admix water. The method includes filling a mix tank with fluid via piping; measuring a target amount of dry additive; releasing the target amount of dry additive into the fluid; circulating the fluid and the target amount of dry additive through the piping and the mix tank to mix the target amount of dry additive into the fluid, which produces admix water; and releasing the admix water from the mix tank.

In some embodiments, measuring the target amount of dry additive includes measuring an initial amount of dry additive, and measuring a secondary amount of dry additive, wherein the secondary amount of dry additive is less than the initial amount of dry additive.

Many modifications are possible without materially departing from the teachings of this disclosure. Accordingly, such modifications are intended to be included within the scope of this disclosure as set forth in the claims.

### BRIEF DESCRIPTION OF THE DRAWINGS

So that the manner in which the above recited features can be understood in detail, a more particular description may be had by reference to embodiments, some of which are illustrated in the appended drawings, wherein like reference numerals denote like elements. It is to be noted, however, that the appended drawings illustrate various embodiments and are therefore not to be considered limiting of its scope, and may admit to other equally effective embodiments.

FIG. 1 is an illustration of an example of a wellsite layout in which a dry additive mixing system is deployed on or coupled with a rig in a manner able to mix dry additives into water for use in cementing operations, according to an embodiment of the disclosure;

FIG. 2 is an isometric view of the dry additive mixing system of FIG. 1;

FIG. 3 is a side view of the dry additive mixing system of FIG. 1;

FIG. 4 is a block diagram of mixing and fluid transfer components of the dry additive mixing system of FIG. 1;

FIG. 5 is a block diagram of electronic components of the dry additive mixing system of FIG. 1;

FIG. 6 illustrates an interface of a controller of the dry additive mixing system of FIG. 1; and

FIG. 7 is a flow diagram depicting a method to mix dry additives into water for use in cementing operations, according to the principles of this disclosure.

### DETAILED DESCRIPTION

In the following description, numerous details are set forth to provide an understanding of some embodiments of the present disclosure. However, it will be understood by those of ordinary skill in the art that the system and/or methodology may be practiced without these details and that numerous variations or modifications from the described embodiments may be possible.

In the specification and appended claims: the terms “connect”, “connection”, “connected”, “in connection with”, and “connecting” are used to mean “in direct connection with” or “in connection with via one or more elements”; and the term “set” is used to mean “one element” or “more than one element”. Further, the terms “couple”, “coupling”, “coupled”, “coupled together”, and “coupled with” are used to mean “directly coupled together” or “coupled together via one or more elements”. As used herein, the terms “up” and “down”, “upper” and “lower”, “upwardly” and downwardly”, “upstream” and “downstream”; “above” and “below”; and other like terms indicating relative positions above or below a given point or element are used in this description to more clearly describe some embodiments of the disclosure.

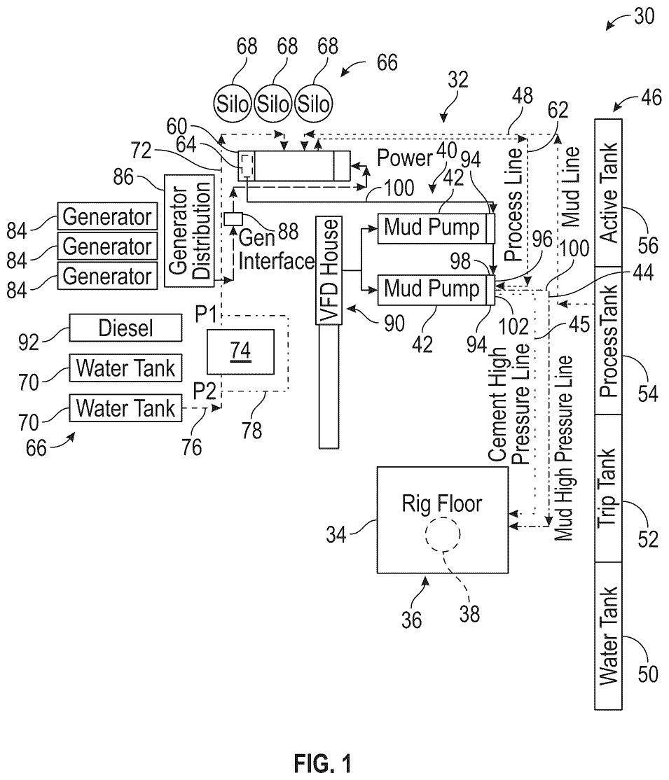

Referring generally to FIG. 1, an example of a wellsite layout 30 is illustrated in which aspects of the dry additive mixing system have been incorporated into a rig 32. In this example, the wellsite layout 30 comprises a rig 32 having a variety of components including a rig floor 34 which may be positioned generally above a well 36 having at least one borehole 38, e.g. a wellbore. A mud pump assembly 40 is positioned on the rig 32 and comprises a plurality of mud pumps 42. The mud pumps 42 are operated to pump mud to the rig floor 34 via a mud line 44 and then down into the borehole 38 to facilitate a drilling operation. The mud pumps 42 also may be operated to pump cementing fluid to the rig floor 34 via a separate cementing line 45 and then down into borehole 38 to facilitate a cementing operation. It should be noted the drilling equipment for drilling borehole 38 has not been illustrated so as to facilitate explanation of the mud pumping operation and cementing operation.

By way of example, mud may be supplied to the mud pumps 42 from a mud supply 46 via mud supply lines 48. The mud supply 46 may comprise a mud pit and various supporting components, such as a water tank 50, a trip tank 52, a process tank 54, and an active tank 56. A cement mixing skid 60 also is in communication with mud pumps 42 via a process line or lines 62. In some instances, the cement mixing skid 60 may be used as mud mixing hopper.

For example, the illustrated embodiment comprises a cement mixing system 64 which is located on the cement mixing skid 60. In some embodiments, the cement mixing skid 60 along with cement mixing system 64 may be integrated into the rig 32. This type of integrated system may be used to mix mud additives in lieu of mud mixing hopper 58. The cement mixing system 64 may be operated to mix a cementing fluid formed from suitable constituents. The constituents may be supplied via supply tanks 66 that may include, for example, silos 68 containing cement, other dry materials, additives, and/or other cementing fluid constituents. The supply tanks 66 also may comprise water tanks 70 which contain water for mixing with the cement and other cementing fluid constituents. The water may be supplied to cement mixing system 64 via a suitable first water line 72. In some instances, the cement mixing system 64 may also be used as a mud mixer.

Further, the overall wellsite layout 30 may comprise a dry additive mixing system 74 used to mix dry additives into water for mixing with the cement. More specifically, the dry additive mixing system 74 may be fluidly placed downstream of the water tanks 70 and upstream of the cement mixing system 64. Thus, the dry additive mixing system 74 is fluidly between the water tanks 70 and the cement mixing system 64. Water is provided to the dry additive mixing system 74 via a second suitable water line 76. In the dry additive mixing system 74, dry additives are added and mixed into the water, producing admixed water. This admixed water is delivered from the dry additive mixing system 74 to the cement mixing system 64 via the first suitable water line 72. The dry additive mixing system may include hoppers to store the dry additives. Further supplies of the dry additives may be stored in the silos 68. Additionally, the dry additive mixing system 74 may be bypassed via the third suitable water line 78, which connects a first point P1 along the first suitable water line 72 downstream of the additive mixing system to a second point P2 along the second suitable water line 76 upstream of the dry additive mixing system 74.

Additionally, the overall wellsite layout 30 may comprise one or more generators 84 used to provide rig electric power via a generator distribution system 86. However, the rig power may be provided via grid power or other types of auxiliary mobile power. In the example illustrated, the electric power is supplied to a generator interface 88 which, in turn, distributes power to electrically powered components, such as the mud pumps 42, mud mixer, cement mixing system 64, and the dry additive mixing system 74. In some embodiments, the dry additive mixing system 74 includes an independent power source.

In some embodiments, the mud pumps 42 may be operated/controlled via a variable frequency drive (VFD) 90 which is coupled with the generators 84. The generator interface 88, VFD 90, and/or other control components may be used to provide a common control system for both mud pumping and cementing operations. Depending on the location of the wellsite layout 30 and/or available electric power, the generators 84 may be diesel powered generators which include diesel engines supplied with diesel from a suitable diesel tank 92. However, other sources of power may be used to directly provide electric power to the rig 32.

In some embodiments, the same mud pumps 42 are used for both a mud pumping operation and the cementing operation, the pumping of mud and the pumping of cementing fluid are separated. Additionally, the mud pump assembly 40 is constructed to facilitate cleanout of mud and cement to avoid contamination of the cement with mud or vice versa as the mud pumps 42 are switched between the mud pumping operation and the cementing operation. According to one embodiment, this dual use of the same mud pumps 42 is facilitated by providing the mud pump assembly 40 with a suction manifold 94 having a separate mud supply 96 and cement supply 98 (see FIG. 1). Furthermore, the mud and the cementing fluid may be discharged to the rig floor 34 and then to the borehole 38 via a mud outlet 100 connected to mud line 44 and a separate cementing fluid outlet 102 connected to the cementing fluid line 45. In some embodiments, cement mixing system 64 includes a cement mixer and a high pressure pump combined into a single unit. Thus, in such embodiments, use of the mud pumps 42 for high pressure pumping is optional.

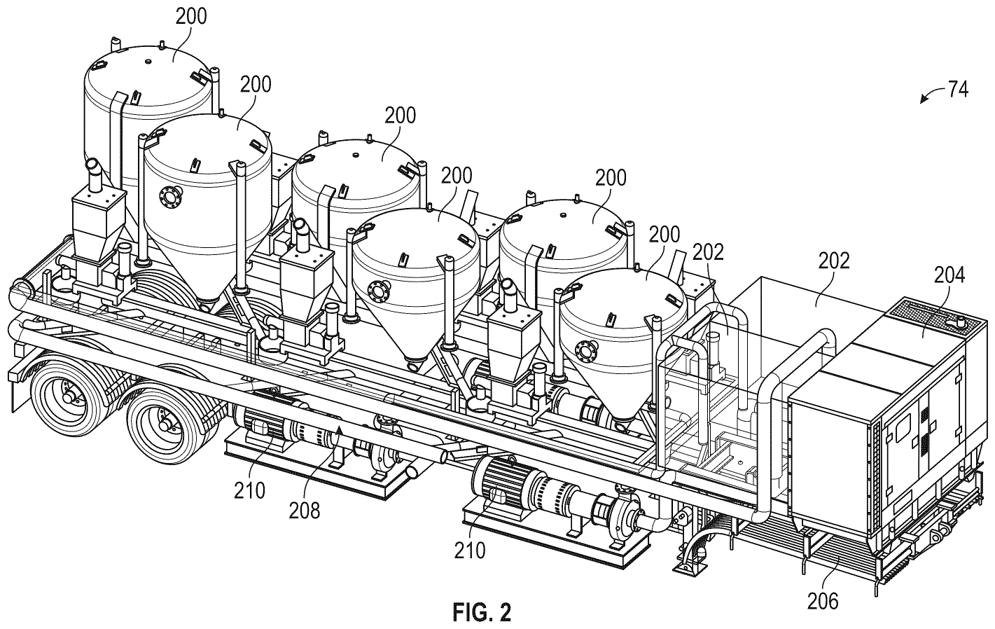

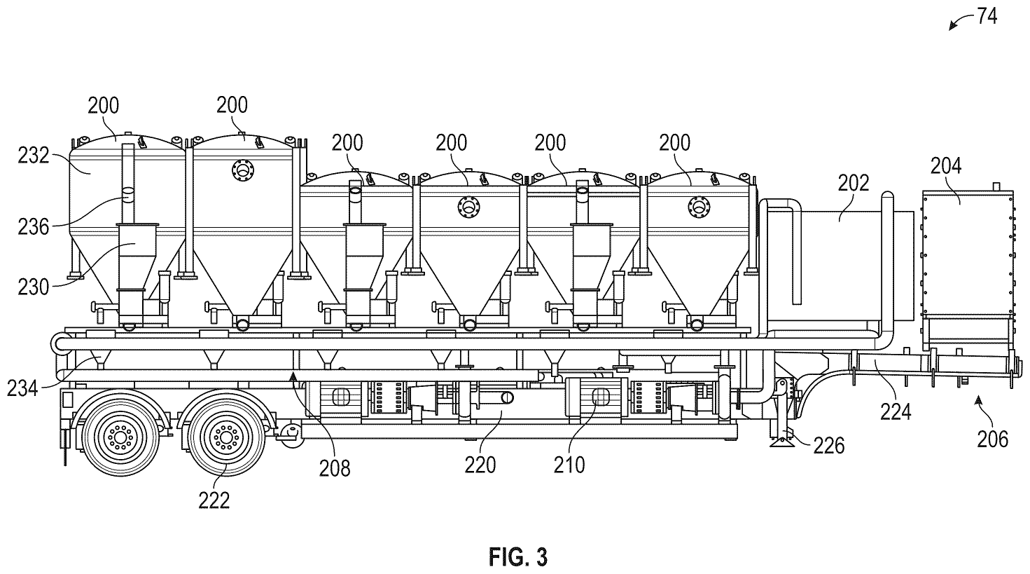

Turning to FIGS. 2 and 3, the additive mixing system 74 includes a plurality of additive dispensers 200, a plurality of mix tanks 202, and a controller 204, supported on a trailer 206. The plurality of additive dispensers 200 and the plurality of mix tanks 202 are connected to one another via piping 208, as will be described in greater detail below. Water to be mixed with additives dispensed by the plurality of additive dispensers 200 is circulated through the piping 208 and the plurality of mix tanks 202 by a plurality pumps 210.

Referring to FIG. 3, the trailer 206 includes a bed 220 supported by traction elements (e.g., wheels 222) and connected to a platform 224, which is vertically offset from the bed 220. Further, a plurality of support legs 226 collapsibly extend from the trailer 206. The bed 220 supports the plurality of additive dispensers 200. The platform 224 supports the plurality of mix tanks 202 and the controller 204. Thus, the additive mixing system 74 is mobile and may be pulled by a tractor along a roadway and/or loaded onto a rail car (not shown).

Each additive dispenser 200 includes a weight batch hopper 230 connected to a storage hopper 232 and an eductor 234. A transfer auger 236 moves dry additive from the storage hopper 232 to the weight batch hopper 230. In some embodiments, the transfer auger 236 includes a primary auger screw and a secondary auger screw (not shown). The primary auger screw is larger than the secondary auger screw. Thus, the primary auger screw transfers more dry additive per rotation than the secondary auger screw.

In operation, the primary auger screw is rotated to move an initial amount of dry additive from the storage hopper 232 to the weight batch hopper 230. Further in operation, the secondary auger screw is rotated to move a secondary amount of dry additive into the weight batch hopper 230 until a target amount of dry additive in the weight batch hopper 230 is reached. Thus, the primary auger screw delivers a bulk, rough estimate amount of dry additive to the weight batch hopper 230 and the secondary auger screw finely transfers dry additive to the weight batch hopper 230 to achieve the target amount in the weight batch hopper 230. Thus, the secondary amount of dry additive is less than the initial amount of dry additive. Further, the target amount of dry additive is the sum of the initial amount and the secondary amount. In some embodiments, dry additive is measured by volume based on a first number of rotations of the primary auger screw and a second number of rotations of the secondary auger screw. In some embodiments, dry additive is measured by weight using weight sensors (not shown) connected to the weight batch hopper 230. Additionally, in operation, the eductor 234 delivers the target amount of dry additive from the weight batch hopper 230 into the piping 208.

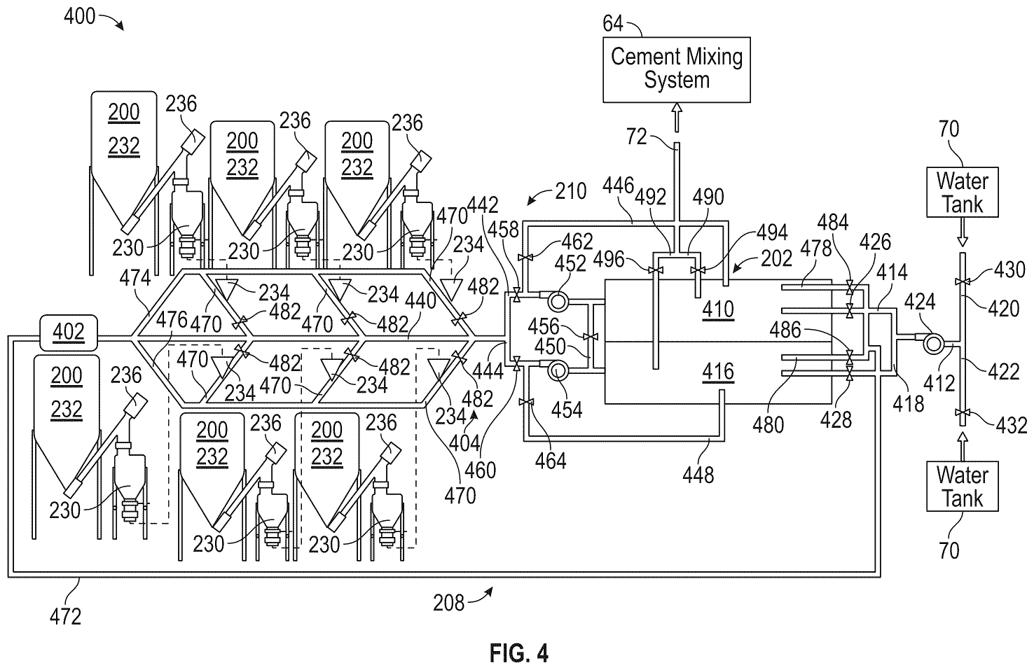

As shown in FIG. 4, mixing and fluid transfer components 400 of the dry additive mixing system 74 (shown in FIGS. 1-3) include the plurality of additive dispensers 200, the plurality of mix tanks 202, the piping 208, the plurality of pumps 210, a static mixer 402, and a plurality of valves 404.

More specifically, a first mix tank 410 is downstream of and connected to a supply line 412 via a first supply branch 414. Similarly, a second mix tank 416 is downstream of and connected to the supply line 412 via a second supply branch 418. The supply line 412 is downstream of and connected to a first supply inlet 420 and a second supply inlet 422. Fluid (e.g., water) is moved through the supply line 412 by a first supply pump 424 (e.g., a centrifugal pump). The first supply inlet 420 and the second supply inlet 422 are connected to the water tank 70. A first supply valve 426 controls flow through the first supply branch 414. A second supply valve 428 controls flow through the second supply branch 418. A third supply valve 430 controls flow through the first supply inlet 420. A fourth supply valve 432 controls flow through the second supply inlet 422. The first mix tank 410 and the second mix tank 416 may define any suitable volume to hold, retain, and mix fluid. In some embodiments, the first mix tank 410 and the second mix tank 416 are each sized to accommodate approximately 20 barrels (approximately 3200 liters) of fluid. In some embodiments, the first mix tank 410 and the second mix tank 416 differ in volume.

In the embodiment illustrated in FIG. 4, the first mix tank 410 is upstream of and connected the transfer line 440 via a first transfer inlet 442. Similarly, the second mix tank 416 is upstream of and connected to the transfer line via a second transfer inlet 444. The first mix tank 410 is further connected to the first transfer inlet 442 via a first bypass line 446. Likewise, the second mix tank 416 is further connected to the second transfer inlet via a second bypass line 448. The first transfer inlet 442 is connected to the second transfer inlet 444 via a diverter line 450. Fluid is moved through the first transfer inlet 442 by a first transfer pump 452. Fluid is moved through the second transfer inlet 444 by a second transfer pump 454. A first diverter valve 456 controls flow through the diverter line 450. A first transfer valve 458 controls flow through the first transfer inlet 442. A second transfer valve 460 controls flow through the second transfer inlet 444. A first bypass valve 462 controls flow through the first bypass line 446. A second bypass valve 464 controls flow through the second bypass line 448.

With reference to FIG. 4, the first transfer pump 452 and the second transfer pump 454 are downstream of the diverter line 450. The first transfer valve 458 and the first bypass valve 462 are downstream of the first transfer pump 452. The second transfer valve 460 and the second bypass valve 464 are downstream of the second transfer pump 454. Further, the first transfer valve 458 is downstream of the first bypass line 446. Similarly, the second transfer valve 460 is downstream of the second bypass line 448.

Each additive dispenser 200 is downstream of and connected to the transfer line 440 via an additive introduction line 470. Further, one or more of the additive introduction lines 470 are upstream of and connected to a mix return line 472 via a first mix return branch 474. In some instances, one or more of the additive introduction lines 470 are upstream of and connected to the mix return line 472 via a second mix return branch 476. The first mix tank 410 is downstream of and connected to the mix return line 472 via a third mix return branch 478. Similarly, the second mix tank 416 is downstream of and connected to the mix return line 472 via a fourth mix return branch 480. The static mixer 402 is fluidly placed along the mix return line 472. Each additive dispenser 200 is connected to one of the additive introduction lines 470 via its respective eductor 234. An additive introduction valve 482 is fluidly placed along and controls flow through each additive introduction line 470. Along each additive introduction line 470, the additive introduction valve 482 is upstream of the eductor 234. A first mix return valve 484 controls flow through the third mix return branch 478. A second mix return valve 486 controls flow through the fourth mix return branch 480.

The first mix tank 410 is upstream of and connected to the first suitable water line 72 via a first output branch 490. Similarly, the second mix tank 416 is upstream of and connected to the first suitable water line 72 via a second output branch 492. A first output valve 494 controls flow through the first output branch 490. A second output valve 496 controls flow through the second output branch 492. The first suitable water line 72 is upstream of and connected to the cement mixing system 64.

As shown in the illustrated example of FIG. 4, the plurality of mix tanks 202 thus includes the first mix tank 410 and the second mix tank 416.

Further, the piping 208 thus includes the supply line 412, the first supply branch 414, the second supply branch 418, the first supply inlet 420, the second supply inlet 422, the transfer line 440, the first transfer inlet 442, the second transfer inlet 444, the first bypass line 446, the second bypass line 448, the diverter line 450, the additive introduction line 470, the mix return line 472, the first mix return branch 474, the second mix return branch 476, the third mix return branch 478, the fourth mix return branch 480, the first output branch 490, the second output branch 492, and the first suitable water line 72.

Additionally, as shown in the illustrated example of FIG. 4, the plurality of pumps 210 thus includes the first supply pump 424, the first transfer pump 452, and the second transfer pump 454.

Moreover, the plurality of valves 404 includes the first supply valve 426, the second supply valve 428, the third supply valve 430, the fourth supply valve 432, the first diverter valve 456, the first transfer valve 458, the second transfer valve 460, the first bypass valve 462, the second bypass valve 464, the additive introduction valve 482, the first output valve 494, and the second output valve 496.

In operation, the plurality of pumps 210 are selectively and variously activated (e.g., turned on and off, energized, engaged, etc.) to circulate fluid (e.g., water, water mixed with dry additives, admixed water, etc.) through the additive mixing system 74 via the plurality of mix tanks 202, the piping 208, and the plurality of valves 404.

Additionally, in operation, the plurality of valves 404 are selectively and variously actuated (e.g., opened and closed) to selectively fill one or more of the plurality of mix tanks 202 with fluid, selectively churn fluid through one or more of the plurality of mix tanks 202, selectively circulate fluid past one or more of the plurality of additive dispensers 200, selectively flush one or more of the plurality of mix tanks 202, selectively flush the piping 208, and selectively release admixed water to the cement mixing system 64.

The transfer augers 236 are selectively and variously activated to measure dry additives from the storage hoppers 232 into the weight batch hoppers 230. As discussed above, each transfer auger 236 is adapted to mete and/or measure out initial approximate bulk quantities of dry additive and subsequently selectively mete and/or measure out more precise quantities of dry additive until a target quantity of the dry additive is reached in the respective weight batch hopper 230.

Additionally in operation, the eductors 234 are selectively and variously actuated (e.g., opened and closed) to introduce (e.g., release, inject, dump, etc.) dry additives (e.g., the measured target quantity of dry additive) into the respective additive introduction lines 470 from the weight batch hoppers 230. In some instances, the eductors 234 remain closed while dry additive is measured out and accumulates in the weight batch hoppers 230. In these such instances, the eductors 234 are actuated to open and release dry additive into the additive introduction lines 470 after the target quantity of dry additive has been measured out and accumulated in the weight batch hopper 230. In some instances, the eductors 234 are actuated to remain open and release dry additive into the additive introduction lines 470 as the transfer augers 236 measure out the dry additive. In these such instances, the dry additive passes through the weight batch hopper 230 directly into additive introduction lines 470. Once the dry additive is released into the piping 208, the static mixer 402 and the plurality of mix tanks 202 ensure that the dry additive is well-mixed into the fluid, thus producing admix water.

It should be understood and appreciated that by selectively and variously activating and/or actuating the eductors 234, the transfer augers 236, the plurality of pumps 210, and the plurality of valves 404, the first mix tank 410 and the second mix tank 416 may alternate being filled and producing admix water. Thus, a batch of produced admix water may be released to the cement mixing system 64 while another subsequent batch is being prepared. It should also be understood and appreciated that the target quantities of dry additive measured out to produce admix water are based on the respective volumes of the first mix tank 410 and the second mix tank 416 and desired concentrations of dry additive in the admix water.

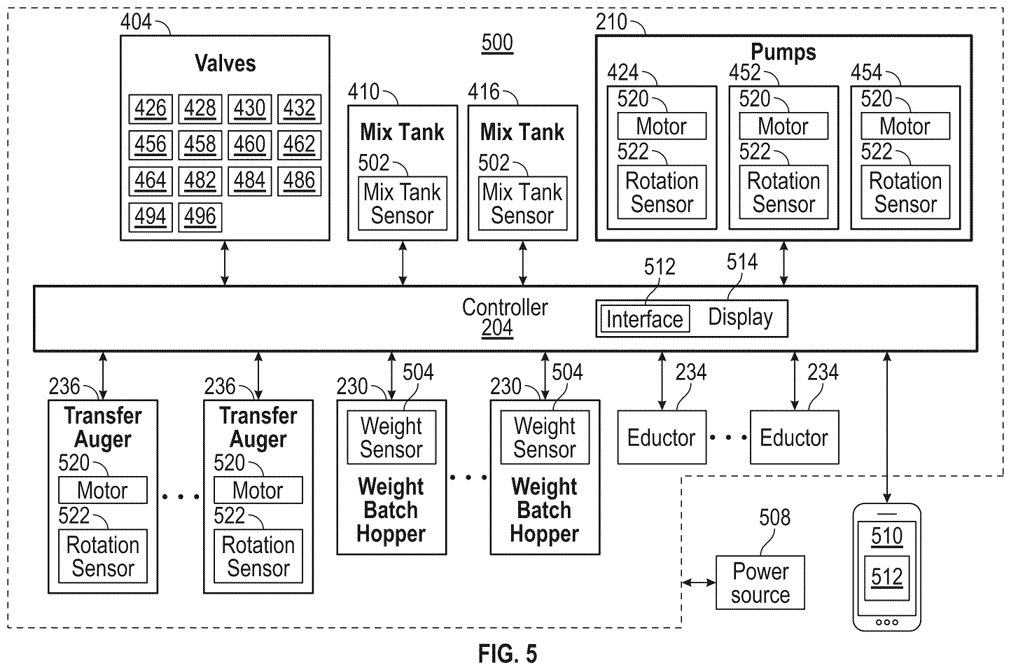

Turning now to FIG. 5, electronic components 500 of the dry additive mixing system 74 (shown in FIGS. 1-3) may include the controller 204, the plurality of pumps 210, the eductors 234, the transfer augers 236, the plurality of valves 404, a plurality of mix tank sensors 502, and a plurality of weight sensors 504. In some embodiments, at least one of the plurality of mix tank sensors 502 is disposed in the first mix tank 410 and in the second mix tank 416, respectively. In some embodiments, at least one of the plurality of weight sensors 504 is disposed in each weight batch hopper 230. The electronic components 500 are powered by a suitable power source 508 (e.g., a generator, an electrical distributor, etc.). In some embodiments, the power source 508 is on board the dry additive mixing system 74.

The controller 204 is in communication with and controls the plurality of pumps 210, the eductors 234, the transfer augers 236, the plurality of valves 404, the plurality of mix tank sensors 502, and the plurality of weight sensors 504. In some embodiments, the controller 204 is in further communication with a remote computing device 510 (e.g., a smartphone, a laptop computer, a desktop computer, a handheld device, etc.). Communications to and from the controller 204 may be wired and/or wireless. A user may enter one or more inputs into the controller 204 via an interface 512, which, in some embodiments, is transmitted to the remote computing device 510. The interface 512 may be displayed via a display 514 of the controller 204.

The first supply pump 424, the first transfer pump 452, the second transfer pump 454 and the transfer augers 236 each include an electric motor 520 and a rotation sensor 522. Further, the eductors 234, the first supply valve 426, the second supply valve 428, the third supply valve 430, the fourth supply valve 432, the first diverter valve 456, the first transfer valve 458, the second transfer valve 460, the first bypass valve 462, the second bypass valve 464, the additive introduction valves 482, the first mix return valve 484, the second mix return valve 486, the first output valve 494, and the second output valve 496 are electrically actuated (e.g., via a solenoid).

More specifically, in operation, the controller 204 communicates with and controls the motors 520 and the plurality of valves 404 to variously and selectively circulate fluid through the mixing and fluid transfer components 400 (shown in FIG. 4), fill the first mix tank 410 and/or the second mix tank 416, and release admix water from the first mix tank 410 and/or the second mix tank 416. Also in operation, the controller 204 further communicates with and controls the motors 520 to transfer dry additive from the storage hoppers 232 to the weight batch hoppers 230 (shown in FIG. 4).

Additionally, in operation, the controller 204 communicates with and controls the rotation sensors 522 to measure dry additive quantities, monitor fluid volume in the first mix tank 410 and/or the second mix tank 416, and monitor fluid flow rate through the piping 208 (shown in FIG. 4). As explained above, the dry additive quantities are based on numbers of auger screw rotations in the transfer augers 236. Additionally, the fluid volume and flow rate are based on numbers of rotations of each of the plurality of pumps 210.

Also in operation, in some embodiments, the controller 204 communicates with and controls the mix tank sensors 502 to monitor dry additive concentrations in admix water. Moreover, in operation, in some embodiments, the controller 204 communicates with and controls the weight sensors 504 to measure and/or monitor dry additive quantities. Yet further in operation, the controller 204 communicates with and controls the eductors 234 and/or the motors 520 release dry additives into the piping 208 (shown in FIG. 4).

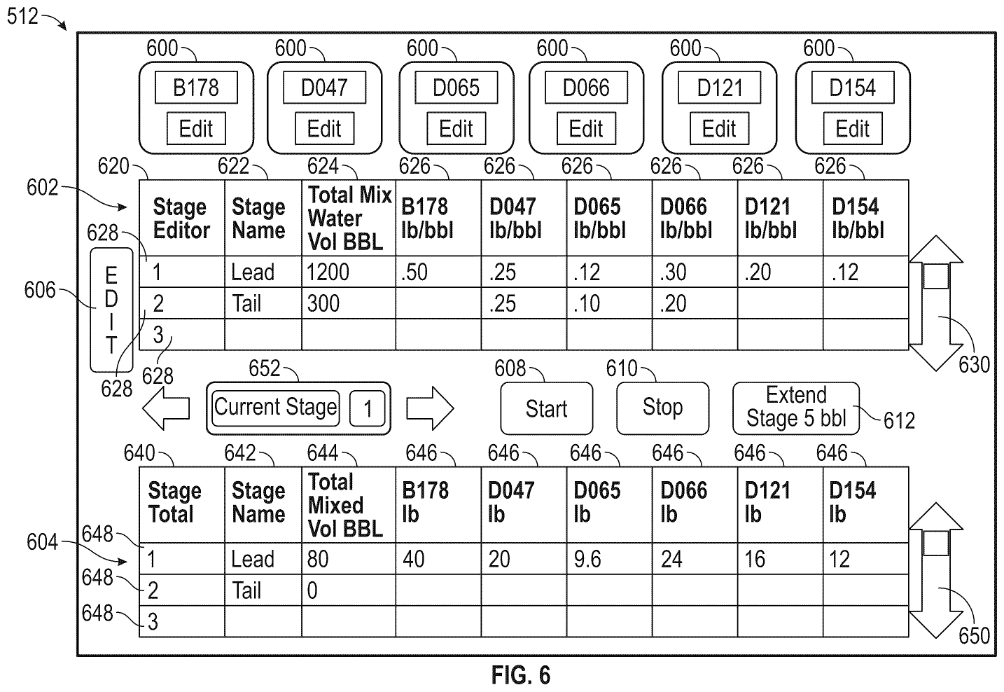

Referring now to FIG. 6, the interface 512 includes a plurality of dry additive input cells 600, a stage setup field 602, and a results table 604. An edit button 606 is associated with the stage setup field 602. A start button 608 and a stop button 610 respectively start and stop a program entered via the stage setup field 602. A stage extension button 612 extends individual stages of a program.

The stage setup field 602 includes a stage editor column 620, a stage name edit column 622, a total mix water volume column 624, and a plurality of dry additive concentration columns 626. The stage setup field 602 further has a plurality of stage edit rows 628. A user may scroll among the stage edit rows 628 using an edit scroll button 630. In operation, a user may name various stages in the stage name edit column 622. Also in operation, for each stage edit row 628, the user may enter a desired mix water volume value in the total mix water volume column 624. Further in operation, for desired stage edit rows 628, the user may enter desired dry additive concentration values under the dry additive concentration columns 626. Thus, the user may build a dry additive introduction and mixing program stage by subsequent stage.

The results table 604 may include a stage total column 640, a stage name column 642, a total mixed water volume result column 644, and a plurality of released dry additive quantity columns 646. The results table 604 further has a plurality of stage results rows 648. A user may scroll among the stage results row 648 using a results scroll button 650. In operation, the stage name column 642 displays names for stages entered via the stage name edit column 622. Also in operation, for each stage results row 648, the total mixed water volume result columns 644 display a water quantity used for that respective stage. Further in operation, for each stage results row 648, the released dry additive quantity columns 646 display quantity values of dry additive released for that respective stage. Thus, the controller 204 tracks the amounts and types of dry additives in the produced admix water. Further, the user may review admix water production program results stage by subsequent stage. Additionally in operation, the user may select a desired stage to start, end, or extend using a stage selector 652.

It should be appreciated that the user may update the admix water production program via the stage setup field 602 while the admix production program is running. Thus, the user may dynamically update the admix water production program as desired (e.g., to change dry additive concentration values in a particular stage before the dry additive is released).

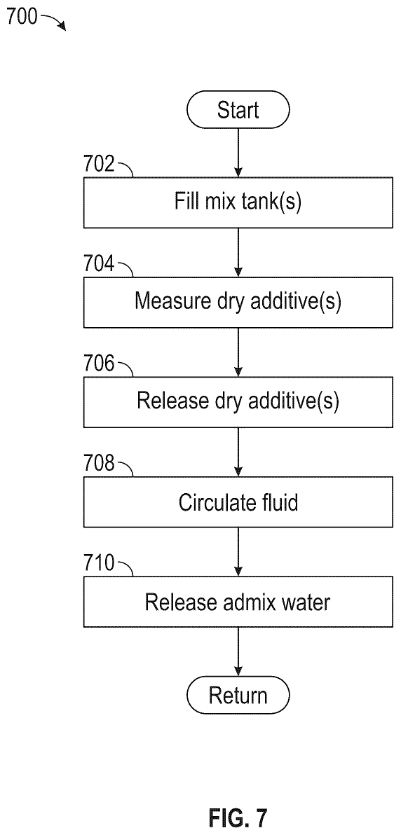

FIG. 7 illustrates a flow diagram depicting a method 700 executable by the controller 204 of FIG. 5 to mix dry additives into water for use in cementing operations. The method 700 starts at block 702, where the controller 204 fills one or more of the plurality of mix tanks 202 (shown in FIG. 5). More specifically, the controller 204 controls the motor 520 of the first supply pump 424, the first supply valve 426, the second supply valve 428, the third supply valve 430, and the fourth supply valve 432 to fill the first mix tank 410 and/or the second mix tank 416 (shown in FIG. 5). The method 700 proceeds to block 704.

At block 704, the controller 204 measures dry additives to be mixed with fluid from the filled one or more of the plurality of mix tanks 202. More specifically, the controller 204 communicates with and controls the respective motors 520 and rotation sensors 522 to turn the transfer augers 236 (shown in FIG. 5) of the desired dry additive dispensers 200 (shown in FIG. 4). For each transfer auger 236, the controller 204 monitors the rotation sensor 522 and controls the motor 520 to rotate predetermined numbers of rotations to measure out an approximate, bulk initial amount of dry additive and a more precise, finely tuned secondary amount of dry additive until a target amount of dry additive in the respective weight batch hopper 230 is reached (shown in FIG. 5). The method 700 proceeds to block 706.

At block 706, the controller 204 releases the dry additives into the piping 208 (shown in FIG. 4). More specifically, the controller 204 communicates with and controls the respective eductors 234 of the desired additive dispensers 200 to selectively open and release measured amounts of dry additive into the piping 208 (shown in FIG. 4). The method 700 proceeds to block 708.

At block 708, the controller 204 circulates fluid through the piping 208 and one or more of the plurality of mix tanks 202. More specifically, the controller 204 communicates with and controls the motors 520 of the plurality of pumps 210 and the plurality of valves 404 (shown in FIG. 5) to move fluid through the piping 208, the static mixer 402, and one or more of the plurality of mix tanks 202 (shown in FIG. 4). The method 700 proceeds to block 710.

At block 710, the controller 204 releases admix water to the cement mixing system 64 (shown in FIG. 4). More specifically, the controller 204 communicates with and controls the motors 520 of the plurality of pumps 210 and the plurality of valves 404 (shown in FIG. 5) to move fluid out of one or more of the plurality of mix tanks 202 (shown in FIG. 4). The method 700 returns to block 702.

Although the preceding description has been described herein with reference to particular means, materials and embodiments, it is not intended to be limited to the particulars disclosed herein; rather, it extends to all functionally equivalent structures, methods, and uses, such as are within the scope of the appended claims.

1. A dry additive mixing system comprising:
a dry additive dispenser including
a storage hopper,
a weight batch hopper connected to the storage hopper, and
a transfer auger configured to move dry additive from the storage hopper into the weight batch hopper;
piping connected to the dry additive dispenser;
a mix tank connected to the piping; and
a controller configured to
control the transfer auger to move dry additive into the weight batch hopper until a target amount of dry additive in the weight batch hopper is reached, and
selectively release the target amount of dry additive into the piping.

2. The dry additive mixing system of claim 1, further comprising a static mixer fluidly placed along the piping.

3. The dry additive mixing system of claim 1, further comprising a plurality of valves fluidly placed along the piping, wherein the controller is configured to control the plurality of valves to selectively fill the mix tank with fluid, selectively release admix water from the mix tank, and selectively circulate fluid through the piping.

4. The dry additive mixing system of claim 3, wherein the plurality of valves are electrically actuable.

5. The dry additive mixing system of claim 1, further comprising a plurality of pumps fluidly placed along the piping, wherein the controller is configured to control the plurality of pumps to selectively fill the mix tank with fluid, selectively release admix water from the mix tank, and selectively circulate fluid through the piping.

6. The dry additive mixing system of claim 5, wherein each of the plurality of pumps includes a rotation sensor.

7. The dry additive mixing system of claim 6, wherein the controller monitors fluid flow rate in the piping and fluid volume in the mix tank via the rotation sensor.

8. The dry additive mixing system of claim 1, wherein the controller is configured to control the transfer auger to measure out an initial amount of dry additive and a secondary amount of dry additive.

9. The dry additive mixing system of claim 8, wherein the secondary amount of dry additive is less than the initial amount of dry additive.

10. The dry additive mixing system of claim 8, wherein the target amount of dry additive is the sum of the initial amount of dry additive and the secondary amount of dry additive.

11. The dry additive mixing system of claim 8, wherein a first auger screw of the transfer auger measures the initial amount of dry additive and a second auger screw of the transfer auger measures the secondary amount of dry additive.

12. The dry additive mixing system of claim 11, wherein the second auger screw is smaller than the first auger screw.

13. The dry additive mixing system of claim 8, wherein the transfer auger includes a rotation sensor.

14. The dry additive mixing system of claim 13, wherein the controller monitors measurement of the initial amount of dry additive and measurement of the secondary amount of dry additive via the rotation sensor.

15. The dry additive mixing system of claim 1, further comprising an eductor connected to the weight batch hopper and the piping, wherein the controller is configured to control the eductor to selectively release the target amount of dry additive into the piping.

16. A dry additive mixing system comprising:
a mix tank;
a dry additive dispenser connected to the mix tank via piping, the dry additive dispenser being configured to dispense a dry additive into the piping; and
a controller in communication with the dry additive dispenser, the controller being programmable to control the dry additive dispenser according to an admix water production program via an interface, wherein a user enters desired dry additive concentration values for one or more stages via the interface.

17. The dry additive mixing system of claim 16, wherein the interface is displayed via one or more of a display of the controller and a remote computing device in communication with the controller.

18. The dry additive mixing system of claim 16, wherein the user may update the admix water production program via the interface dynamically while the admix water production program is running.

19. A method to produce admix water comprising:
filling a mix tank with fluid via piping;
measuring a target amount of dry additive;
releasing the target amount of dry additive into the fluid;
circulating the fluid and the target amount of dry additive through the piping and the mix tank to mix the target amount of dry additive into the fluid, which produces admix water; and
releasing the admix water from the mix tank.

20. The method to produce admix water of claim 19, wherein measuring the target amount of dry additive includes
measuring an initial amount of dry additive, and
measuring a secondary amount of dry additive, wherein the secondary amount of dry additive is less than the initial amount of dry additive.
